(19) United States
(12) Patent Application Publication
(10) Pub. No.: US 2012/0164742 A1
(43) Pub. Date: Jun. 28, 2012

(54) In-Line Derivatization Of Polyaminosaccharide Polymer For Analytical Determination

(75) Inventors: Jianguo Qian, St. Louis, MO (US); Paul Brister, O'Fallon, MO (US)

(73) Assignees: CET, LLC, St. Louis, MO (US); BioMed Protect, LLC, St. Louis, MO (US)

(21) Appl. No.: 13/338,734

(22) Filed: Dec. 28, 2011

Related U.S. Application Data
(60) Provisional application No. 61/427,765, filed on Dec. 28, 2010.

(51) Int. Cl. G01N 21/76; G01N 21/75

(52) U.S. Cl. 436/94

(57) ABSTRACT

An analytic method for the determination of the concentration of polysaccharide polymer in solution comprises the in-line derivatization of the polymer by reaction with sulfonate dye. The reaction results in an analyte-derivative, carried in a mobile phase, that can be detected and quantitatively determined by ultraviolet absorption or by fluorescence measurement. The method can provide sensitive and precise measurement in spite of limited solubility of the analyte.

### CROSS-REFERENCE TO RELATED APPLICATION

This application claims priority to copending U.S. provisional application entitled, “IN-LINE DERIVATIZATION OF POLYAMINOSACCHARIDE POLYMER FOR ANALYTICAL DETERMINATION,” having Ser. No. 61/427,765, filed Dec. 28, 2010, which is entirely incorporated herein by reference.

### FIELD OF THE DISCLOSURE

This disclosure relates to an analytic method for the determination of the quantity of polyaminosaccharide polymer in solution of which dilute chitosan in aqueous solution is an example.

### BACKGROUND

Polyaminosaccharide polymers are used in a variety of medical, food, cosmetic, and anti-microbial applications. The manufacturing of products containing such polymers generally requires analytical measurement of the polymer ingredients to obtain accurate composition and for regulatory purposes.

Chitosan is an example of a polyaminosaccharide that comprises linked glucosamine units and N-acetylglucosamine units. Further, there are several modified-chitosan formulations. As materials made by the deacetylation of chitin, these polymers have varied degrees of deacetylation and free amine groups, and they are used in a wide variety of applications because of their ability to form films, to bind a great many molecular species, e.g., drugs, particles, fluors, and dyes, and to provide micro-encapsulation.

Chitosan is antimicrobial, non-toxic, and is used in medical applications for its hemostatic and mucoadhesive properties, for wound binding and dressing, and for transdermal drug delivery. It is also used as a dietary supplement, for filtering, and to bind dye to textiles containing cellulose.

The solubility of chitosan and modified chitosan materials depends on pH. Chitosan, a linear polymer, is soluble in acid solutions. Consequently, an issue in measuring solutions to determine the concentration of chitosan and similar materials, i.e., the analyte, is the solubility of the material during the measurement process. Dilution of a solution to enable a measurement method or the addition of a reagent may change the pH and affect the solubility. In many cases, reactions or dilutions made as part of an analytical measurement will lead to the precipitation of the polymeric analyte from the solution. As a result, the analytic measurement can be inaccurate, imprecise, irreproducible, or inconsistent, i.e., repeated measurements will have a large standard deviation.

Methods to determine the amount of chitosan, modified chitosan material, or other polyaminosaccharide polymer in solution include nuclear magnetic resonance (NMR), e.g., by the ASTM F2260 method, reflectometry, multi-angle light scattering, thermo-gravimetric analysis, and by a variety of analytical methods based on binding dye or fluors to the analyte with subsequent measurement of ultraviolet (UV) or visible light absorption or fluorescence. Further, NMR and UV absorption have been used to determine the degree of deacetylation.

Because chitosan has very little absorption in the spectral range from 200 nm to 800 nm, chitosan determination by UV or visible light absorption cannot be done with acceptable sensitivity. Colorimetric methods have been reported by derivatization, but the reaction products of chitosan and dye, such as Cibacron Brilliant Red 3B-A are subject to precipitation, which adversely affects the quantitative determination of chitosan. Other methods, such as reaction with metal complex, et al, appear to have unacceptably high detection limits and poor sensitivity, or the practice of the method is complicated and problematic, or the analytic method is slow and requires a long time that is impractical in a manufacturing or regulatory setting.

Colorimetric determination of chitosan has been demonstrated by Muzzarelli (1998) in which sulfonic groups on anionic dyes react with cationic amino groups of the chitosan. He found that selection of Cibacron Brilliant Red 3B-A (CBR) dye provided an absorption peak at 575 nm for detection and measurement of chitosan. He reported a nearly linear calibration curve of absorbance as a function of chitosan concentration for the limited range of chitosan concentration between about 2 and 40 μg/ml. However, he did not obtain a linear or near-linear calibration curve for modified chitosans. Moreover, such a method is susceptible to error because of the formation of precipitate of the chitosan-dye product. The formation of such precipitate depends on the relative concentrations of chitosan material and dye.

In yet another method, o-phthalaldehyde (OPA) is reacted with the amino groups and glucosamine obtained by the hydrolysis of chitosan materials. The OPA-hydrolysate reaction products are produced in pre-column fluorescent derivatization and comprise a fluorescent material that can be detected after chromatographic separation by fluorescent detection (see Zelles, 1988, for example). However, o-phthalaldehyde derivatization is obtained in the alkali pH regime. In contrast, chitosan and modified chitosan are relatively insoluble except at acid pH. Moreover, a high yield of OPA fluorescent species is found only in the alkali pH range. Similarly, the colorimetric assay with o-phthalaldehyde and thiol has been demonstrated in solutions in the presence of proteins and poly-electrolytes for chitosan concentration from about 10 μg/ml to 0.15 mg/ml (Larionova et al, 2009), and the method is performed at pH>8.

Because chitosans can be degraded to glucosamine monomer by hydrolysis, colorimetric determinations based on acid hydrolysis, derivatization with o-phthalaldehyde, and liquid chromatography with UV absorption or fluorescent detection have been reported. (See Eikenes et al 2005.) These methods, generally, involve a lengthy hydrolysis step of many hours duration, commonly about a day and at elevated temperature, and they are subject to inconsistency and irreproducibility because of the sensitivity of chitosan solubility to pH. To reduce the sensitivity of the measurement method to precipitation and inconsistent mixing of the hydrolysate and dye, these methods are best performed with on-line derivatization, i.e., derivatized by automatically mixing the sample with the o-phthalaldehyde by use of an autosampler and a mixing tube volume just prior to injection into the chromatographic column. In this approach, the autosampler syringe serially samples an aliquot of analyte sample and then an aliquot of derivatizing dye, namely the OPA, and then injects the two aliquots that are contained in the syringe into a length of tubing that provides a mixing volume. The mobile phase is then injected into the mixing volume to carry the reacted analyte-dye products and un-reacted analyte and dye into a chromatographic column for separation and then subsequent detection. Detection may be made by light absorption or by fluorescence measurement.

Dilute chitosan compositions in acid solution and containing substantially greater amounts of reactive organic compounds such as heterocyclic materials such as hydantoins pose additional challenge to quantitative determination of the chitosan concentration. This is because of analyte-dye mixing issues, solubility issues, and because of potential chromatographic interference. For an analytical method suitable for manufacturing testing and regulatory purposes, the lengthy time for acid hydrolysis at elevated temperature is not acceptable. In the on-line derivatization method, the pH of the sample is adjusted to about pH=5, and then the sample is added to and mixed in an o-phthalaldehyde solution that is buffered to pH=9.5, with the acidic sample being less than 80% of the buffer capacity. This mixing will lead to precipitation. This makes the prior art method sensitive to the unknown concentration of the analyte sample and the specific geometry and temporal rates of the autosampler sampling and injection into the mixing tube, and the flow rate and geometry of the mixing tube. This limits the dynamic range of this prior art method and can lead to irreproducible measurements and large standard deviation of repeated measurements. Further, the fluorescent yield of the o-phthalaldehyde-glucosamine product degrades rapidly, i.e., in the matter of a few minutes. So this method is subject to constraints by the on-line derivatization instruments and the transport properties of the mobile phase in the chromatographic column. Instrument to instrument variation in auto-sampling and column properties will lead to inconsistencies and method error.

In the course of evaluating the prior art methods, we have discovered that chitosan material can be derivatized by Cibacron Brilliant Red 3B-A (CBR) dye to form a fluorescent product in an acid mobile phase. The reaction product also exhibits light absorption. The fluorescence or light absorption can be used to detect the derivatization product and so determine the concentration of chitosan polymer units in the test sample. Further and surprisingly, we have discovered that an excess of chitosan relative to dye, i.e., a ratio of chitosan molar concentration Cₘ and dye molar concentration Dₘ greater than or equal to a limiting value,

$${R}_{1} = \frac{{C}_{m}}{{D}_{m}} = {k}_{1} \approx 200 ,$$

is necessary to avoid the formation of precipitate of the chitosan-dye reaction product, and R₁ greater than about 13 is necessary to avoid precipitate that results in inaccurate or inconsistent measurements or low detection signal. This constraint means that the syringe sampling and mixing tube approach of the prior art will result in some precipitate being formed as the aliquots of chitosan and dye diffuse and mix because there will always be a region within the fluids wherein R₁<<k₁. Consequently, the methods of the prior art are either inconsistent or have reduced accuracy.

To reduce the formation of precipitate, to obtain a greater dynamic range and improved consistency, and to reduce the sensitivity of the measurement to instrument to instrument characteristics and variations, the method of the instant invention comprises a direct, in-line derivatization that can be performed either without a chromatographic column or with either or both of a pre-derivatization column and a post-derivatization column. For chitosan, the method uses a sulfonate dye, of which Cibacron Brilliant Red 3B-A (CBR) and Cibacron Yellow 3G-P are examples, as a derivatizing agent that results in a detectable product. The direct, in-line derivatization of the instant invention allows for a greater dye concentration to be used although some non-visible or visible precipitate may form. The larger dye concentration enabled by the instant invention results in more derivatization reaction product that leads to a greater absorption detection signal and to a greater fluorescence detection peak area until the increased formation of precipitate with lower R₁ sufficiently reduces the detection signal. Thus, the selection of R₁ for the diagnostic method is a trade between more detection signal, e.g., the fluorescence peak area of the detection signal, and the formation of more precipitate that may impair flow or transport and reduces the amplitude of the detection signal.

### SUMMARY OF THE DISCLOSURE

Disclosed is an analytic method for the determination of polyaminosaccharide polymer in dilute solutions with high accuracy and precision. The method uses direct, in-line derivatization to minimize the precipitate effect, and can use either light absorption detection or fluorescence detection, or both, to decrease, or eliminate the effect of interference by other compounds in the test material. The method has high sensitivity, a low detection limit, and is very reproducible.

In one embodiment, a method for determining the concentration of polyaminosaccharide polymer in a test sample comprises:

flowing a derivatizing dye solution through a tube to a detector;

injecting an aliquot of the test sample into a buffered mobile phase solution;

flowing the buffered mobile phase solution into the tube that contains the flowing derivatizing dye solution;

mixing the test sample and the derivatizing dye solution to form a reaction product by the contact of the dye solution and the test sample;

detecting the reaction product to obtain a quantitative measure; and

comparing the quantitative measure of the reaction product detection with a calibration curve that is established by the quantitative measure of two or more samples containing known concentrations, of which at least two are differing, of the polyaminosaccharide polymer.

An object of the invention is the quantitative determination of the concentration of polyaminosaccharide in a solution. The measure may be percentage by weight, molar concentration if the average molecular weight of the polymer is known, or the concentration of amino groups or monomer units of the polymer. Another object of the invention is to obtain the quantitative determination reproducibly and with minimal standard deviation over a wide dynamic range. Yet another object is to have minimal precipitation of test sample-dye reaction product or a sufficiently small amount of precipitate so that detection signal amplitude is greatly reduced. Precipitation may lead to inconsistency in a set of measurements, and it may change the flow conditions or clog the apparatus used for performing the method.

Another object of the invention is the determination of the amount of polyaminosaccharide polymer in a liquid composition containing said polymer in less than an hour, for example, in about 15 minutes or less, without a polyaminosaccharide polymer hydrolysis step, and further without the lengthy duration or elevated temperature generally associated with a hydrolysis step. Additionally, an object is the determination of the amount of chitosan or modified chitosan in a solution in acid condition by direct measurement of a chitosan-dye or modified chitosan-dye derivative without the need of a hydrolysis step or a measurement of other chitosan or modified chitosan reaction products.

Yet another object of the invention is the determination of the amount of polyaminosaccharide polymer in a sample of a liquid composition containing said polymer by comparison with a standard composition containing such polymer with a known degree of deacetylation (DD) wherein the standard composition polymer is selected to have a DD that is comparable to the DD that is expected of the polymer in the said sample of a liquid composition containing said polymer.

The method may be practiced optionally as a pre-column derivatization in which a chromatography column is situated between the tube containing the mixed test sample, dye, and buffered mobile phase and the detector. The method may also be practiced optionally with a ‘front-end’ column, which may be a size separation column, where the ‘front-end’ column is situated between the location where the test sample is injected into the mobile phase and the tee where the combined test sample and mobile are flowed into the flowing dye solution.

The derivatizing dye may be an anionic dye when the polyaminosaccharide polymer is cationic. An example of such a polymer is chitosan. An example of anionic dye is a sulfonated dye having multiple sulfur groups per unit. An example of such a dye is Cibacron Brilliant Red 3B-A (CBR). Another example of such a dye is Cibacron Brilliant Yellow 3G-P (CBY). In the case of chitosan as the analyte in the test sample and CBR as the derivatizing dye, the reaction product is fluorescent. The detector may be a light absorption detector. When the reaction product is fluorescent, a fluorescence detector may be used.

These and other features and advantages of the present invention will become apparent from the following detailed description, which taken in conjunction with the annexed drawings, discloses embodiments of the present invention.

### BRIEF DESCRIPTION OF THE DRAWINGS

FIG. 1. Schematic of the post-column derivatization method for chitosan. A tee or binary mixer can be used.

FIG. 2. Shown is a chromatogram of a chitosan standard with a TSK-GEL® Size Exclusion column. Analysis is performed with an isocratic elution with 1M citric acid as the mobile phase at a flow rate of 1.0 ml/min. Cibacron Brilliant Red 3B-A was used as the derivatizing reagent and light absorption was monitored at 575 nm for detection, sample injection volume was 60 μl, and column temperature was 24° C. AU is the UV/Vis detector response with arbitrary units.

FIG. 3. Shown are the light absorption spectra of CBR and after the products after CBR reacts with chitosan. HPLC conditions: Mobile phase: 0.10 M citric buffer, pH 2.95, flow rate: 1.0 ml/min. Injection volume: 100 ul. Between the HPLC injection valve and mixer (a Tee), a 1.0 ml loop (0.03″ ID×219 cm TEF tubing was used. Derivatization reagent: 0.50 mg/ml CBR in 0.10 M Citric buffer, pH 2.95. Flow rate: 0.12 ml/min. Between the mixer (a Tee) and the diode array absorption detector, a 0.8 ml reaction loop (0.03″ ID×175 cm TEF tubing was used. Measurements were made at about room temperature, ˜24° C.

FIG. 4. Schematic of direct on-line derivatization for quantitative determination of chitosan with fluorescence measurement. A tee or binary mixer can be used.

FIG. 5. Fluorescence intensity at 600 nm (emission) of CBR (Red line) and Chitosan-CBR reaction product (Black line) are plotted as a function of time. The CBR is seen to be non-fluorescent.

FIG. 6. The fluorescence amplitude is shown as a function of emission wavelength, i.e., an emission scan spectrum. The upper curve (solid line) is the emission scan spectrum for the chitosan-dye derivatization product with an excitation wavelength of 560 nm. The lower curve (dashed line) is the emission scan spectrum for the dye alone with an excitation wavelength of 560 nm. For this comparison, 0.4 mg/ml chitosan of medium molecular weight (MMW) reacts with 0.02 mg/ml derivatizing CBR dye solution. Mobile phase solvent is 0.1 M citric buffer, pH 2.95. Peak emission of the chitosan-dye reaction product is at a wavelength of about 600 nm.

FIG. 7. The fluorescence amplitude is shown as a function of excitation wavelength, i.e., a excitation scan spectrum. The upper curve (solid line) is the excitation scan spectrum for the chitosan-dye derivatization product. The lower curve (dashed line) is the excitation scan spectrum for the dye alone. For this comparison, 0.4 mg/ml chitosan, MMW, reacts with 0.02 mg/ml derivatizing CBR dye solution. The mobile phase solvent is 0.1 M citric buffer with pH=2.95. The excitation of chitosan-dye reaction product yields a peak fluorescence at about 575 nm.

FIG. 8. Shown is the dependence of the fluorescence signal on the mole ratio of chitosan amine unit and dye. The concentration of the chitosan amine unit is 0.62 mM, and the dye concentration is varied from 0.002 mM to 0.5 mM.

FIG. 9. Shown are the fluorescence signals as a function of time with comparison of absorption detection and fluorescence detection. (a) Determination of chitosan in a test sample comprising a chitosan composition (HR2010) and chitosan standard (medium molecular weight from Sigma) by the direct in-line derivatization method with the absorption detection at 575 nm; (b) Determination of chitosan in a test sample comprising a chitosan composition (HR2010) and chitosan standard (medium molecular weight from Sigma) by the direct in-line derivatization method with fluorescence detection. The excitation wavelength is 560 nm, the emission wavelength is 600 nm.

FIG. 10. Shown is a comparison of the calibration curves for a test sample injection aliquot volume of 50 μl (a) and 100 μl (b). In these measurements, fluorescence detection is used. For these measurements the test parameters were as follows: 0.1 M citric buffer mobile phase with pH=2.95, the flow rate is 1.0 ml/min; the CBR derivatization reagent dye solution: 0.1 mg/ml CBR in 0.1 M citric buffer, the flow rate is 0.50 ml/min. The reaction loop is 800 μl.

FIG. 11. Shown is the calibration curve of the direct in-line derivatizing method with fluorescence detection, excitation=560 nm, emission=600 nm, 100 μl injection.

FIG. 12. Shown are the fluorescence signals as a function of time for chitosan determination by direct in-line derivatization with fluorescence detection. Injection volume is 60 μl. Excitation=560 nm, emission=600 nm. With selection of an appropriate dye concentration in the mobile phase, the method can measure chitosan in the μg/ml range. The upper curve (solid line) is the signal for 5 μg/ml. The lower curve (dashed line) is the signal for 2 μg/ml.

FIG. 13. Fluorescence intensity as a function of time that shows the difference between Cibacron Yellow 3G-P (lower, dashed line) and chitosan/Cibacron Yellow 3G-P (upper, solid line). The dye alone has almost no fluorescence amplitude in comparison with the chitosan/CBY.

FIG. 14. The molecular structure of several sulfonates dyes is shown. Of the dyes shown, only Cibacron Red 3B-A/chitosan and Cibacron Yellow 3G-P/chitosan showed useful fluorescence signals. Yellow 3G-P/chitosan produced a smaller fluorescence signal than Red 3B-A/chitosan.

### DETAILED DESCRIPTION

The concentration of polyaminosaccharaide polymer, the analyte, in a solution is determined by derivatization with a dye in a flowing mobile phase with subsequent detection of light absorption or fluorescence to obtain a quantitative measurement that is compared with a calibration curve that is obtained by the quantitative measurement of two or more samples of known concentration of analyte, and where at least two of the known sample concentrations are differing.

Polyaminosaccharides include chitosan and modified chitosan materials, herein referred to generically as chitosans. Modified chitosans include N-carboxymethyl chitosan (NCMCH), N-carboxybutyl chitosan (NCBCh), 5-hydroxy-2-furaldehyde (NHMFCh), and others. Derivatizing dyes include sulfonates dyes that have multiple sulfur groups per unit. In one embodiment for the measurement of chitosan, a cationic polymer, the dye is anionic and has 4 sulfonates per molecular unit. An example is Cibacron Brilliant Red 3B-A (CBR). The concentration of dye must be sufficient so that the derivatization reaction with chitosan results in the number of reacted sites on the polymer being maximum, and so the concentration of polymer can be determined.

Chitosan is poorly soluble in pure water and insoluble in most organic solvent. It is soluble in acidic solution. If ratio of chitosan concentration and CBR concentration is less than k₁, a limiting value, then the reaction products will be precipitated. To demonstrate this, an experiment was performed. Mixtures of CBR solution and chitosan solution were prepared with various values of R₁. In the experiment, the concentration of CBR was held constant and the concentration of chitosan was varied over a range of interest. The formation of precipitate was determined by visual observation of the solution. Table 1a lists the test results. The data show that the ratio

$${R}_{1} = \frac{{C}_{m}}{{D}_{m}}$$

must ≧200 to avoid generally the formation of visible precipitate.

TABLE 1a
$Demonstration of Precipitation as a function of {R}_{1} = \frac{{C}_{m}}{{D}_{m}} .$

| Dye | Chitosan MMW | R₁ = MMW amine unit/dye | |
|---|---|---|---|
| (mM) | (mM-unit amine) | (M/M) | Visible Precipitate |
| 0.010 | 0.31 | 31.1 | Yes |
| 0.010 | 0.62 | 62.1 | Yes |
| 0.010 | 1.24 | 124.3 | Yes |
| 0.010 | 1.86 | 186.4 | Yes |
| 0.010 | 2.48 | 248.5 | No |
| 0.010 | 3.11 | 310.6 | No |
| 0.010 | 3.73 | 372.8 | No |
| 0.010 | 4.97 | 497.0 | No |
| 0.010 | 6.21 | 621.3 | No |

TABLE 1b
$Demonstration of Precipitation as a function of {R}_{1} = \frac{{C}_{m}}{{D}_{m}} .$

| | | R₁ = MMW | | |
|---|---|---|---|---|
| Dye | Chitosan MMW | amine unit/dye | Precipitate | Fluorescence |
| (mM) | (mM-unit amine) | (M/M) | (Observation) | Peak Area |
| 0.0025 | 0.62 | 248.5 | marginally | 253878 |
| | | | detectable | |
| 0.0035 | 0.62 | 177.5 | very little | 360777 |
| 0.0050 | 0.62 | 124.3 | little | 502943 |
| 0.0055 | 0.62 | 113.0 | Yes | 548314 |
| 0.0060 | 0.62 | 103.5 | Yes | 608433 |
| 0.0065 | 0.62 | 95.6 | Yes | 662287 |
| 0.0075 | 0.62 | 82.8 | Yes | 770646 |
| 0.0085 | 0.62 | 73.1 | Yes | 840938 |
| 0.0100 | 0.62 | 62.1 | Yes | 1011094 |
| 0.0150 | 0.62 | 41.4 | Yes | 1425127 |
| 0.0250 | 0.62 | 24.9 | Yes | 2084533 |
| 0.0400 | 0.62 | 15.5 | Yes | 2687729 |
| 0.0450 | 0.62 | 13.8 | Yes | 2491452 |
| 0.0500 | 0.62 | 12.4 | Yes | 1893240 |
| 0.0750 | 0.62 | 8.3 | Lots | 2876 |
| 0.1000 | 0.62 | 6.2 | Lots | 3926 |

A second experiment was performed to determine the fluorescence peak area as dye concentration is varied for a sequence of measurements for a solution with constant chitosan concentration. For this experiment, the formation of precipitate was determined by centrifugation of the solution and observation of a resulting ‘pellet’. The effect of mole ratio of chitosan amine unit and dye on fluorescence and precipitation are show in Table 1b. The laboratory measurement of fluorescence peak area and the observation of the formation of precipitation were performed with a constant chitosan concentration of 0.62 mM amine units, and the dye concentration was varied from 0.0025 mM to 0.1 mM. The change in fluorescence signal as a function of mole ratio of chitosan amine unit to dye (M/M) is shown in FIG. 8. As seen in Table 1b, when R₁, the mole ratio of chitosan amine unit and dye is greater than 200, there is no significant precipitation. When R₁ is less than 200, some precipitation is observed as a post-centrifugation pellet, however, the greater amount of dye results in a larger absorption detection signal or a greater fluorescence detection peak area up to the point where the competition by formation of precipitate results in a net reduction in the amplitude of the signal. When R₁ is less than 10, almost all chitosan is precipitated and the fluorescence peak area is greatly reduced. The maximum fluorescence detection peak area is obtained when the mole ratio is between about 13 and about 25 in spite of precipitation being formed.

The direct, in-line derivatization of the instant invention allows for a greater dye concentration to be used although some non-visible or visible precipitate may form. The larger dye concentration enabled by the instant invention results in more derivatization reaction product that leads to a greater absorption detection signal and to a greater fluorescence detection peak area until the increased formation of precipitate with lower R₁ sufficiently reduces the detection signal. Thus, the selection of R₁ for the diagnostic method is a trade between more detection signal, e.g., the fluorescence peak area of the detection signal, and the formation of more precipitate that may impair flow or transport and reduces the amplitude of the detection signal.

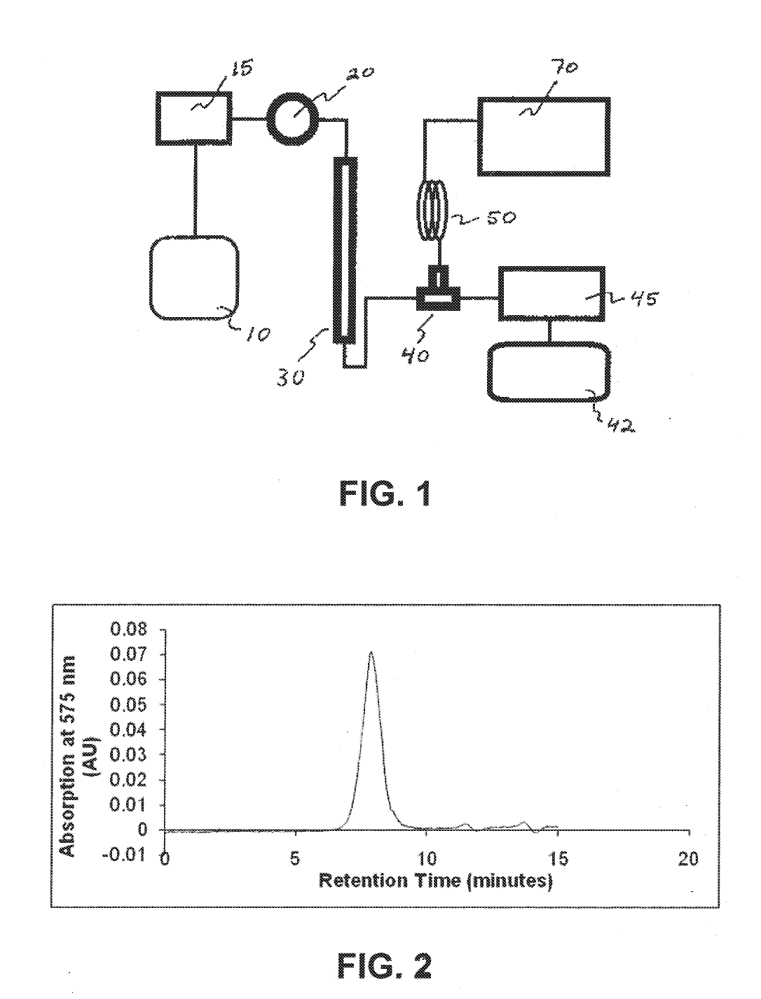

In one embodiment of the method, the apparatus is configured as shown in FIG. 1. The apparatus comprises an analytical column 30, a binary mixer or tee 40, a reaction loop 50, and a detector 70. A mobile phase 10 is transferred by a pump 15 into an injection valve 20 that injects the analyte containing sample and mobile phase into the analytical column 30. The material exiting from the column enters the mixer or tee 40. Also entering the mixer or tee is the derivatizing agent 42 that is injected via a metering pump 45. The mobile phase carrying the analyte and the derivatizing agent exit the mixer or tee 40 and are conveyed through a reaction loop 50 to a detector 70. In one embodiment, the injection of test sample aliquot is made through an injection valve 20 that is a 6-port valve assembly as is typically found in use in automatic samplers that are widely used in chromatography systems. In this embodiment a size separation column is used as the analytical column 30 prior to injection of the buffered mobile phase and test sample aliquot through the tee 40 into the tube comprising the reaction loop 50 that contains the flowing dye solution comprising the derivatizing agent 42. In one embodiment, because the chitosan-CBR product is well known to have a strong absorption peak at about 575 nm, light absorption detection can be performed to obtain absorbance as a quantitative measure that can be compared to a calibration curve established from measurements of known concentration samples.

Chitosan is quantitatively determined by isolating from other components in the formulation by size exclusion chromatography (SEC) followed by post-column derivatization with Cibacron Brilliant Red 3B-A a light absorbing species using apparatus with the configuration shown in FIG. 1. In another embodiment, the analysis is performed with a TSK-GEL®Size Exclusion (PW-Type) HPLC Column with an isocratic elution with 0.10 M citric buffer as the mobile phase at a flow rate of 1.0 ml/min. Light absorption detection is monitored at 575 nm for the derivatized chitosan. Sample injection volume is 60.0 μl, and column temperature is nominally room temperature (24±2° C.). Samples and standards are diluted within the method dynamic range, e.g. 0.1 and 1.0 mg/ml analyte. Quantitative determination of chitosan is accomplished by comparing the sample absorption peak area to a calibration curve established from data of the absorption peak area of two or more dilutions solutions made from known concentration materials, i.e., chemical reference standards.

To perform the method in this embodiment, illustrative materials, conditions, and procedures are described below.

### Equipment

Hitachi D-7000 HPLC system with L-7455 diode array UV-Vis detector, L-7200 autosampler and L-7100 pump, or an equivalent system.
Secondary Pump for post column derivatization capable of delivering up to 1.5 ml/min.
Analytical column: TSK-GEL® Size Exclusion (PW-Type) HPLC Column phase GMPWₓ₁, 30 cm×7.8 mm, 13 μm particle size (Sigma Aldrich #808025) with TSK-GEL® Size Exclusion (PW-Type) HPLC Guard Column GMPWₓ₁, 4 cm×6.0 mm, 12 μm particle size (Sigma Aldrich #808033)
HPLC autosampler vials: 1.6 ml, glass or HDPE
Adjustable Transfer pipetters for dilutions (Eppendorf type covering range of 2 μl to 2.5 ml). Typical analyte and standard aliquots should comprise approximately 20-1000 μl.
Disposable pipetter tips to avoid cross contamination
Dilution vials

### DEFINITIONS

DIW=De-ionized water

HDPE=High density Polyethylene

HPLC=High Performance Liquid Chromatography

RSD=Relative Standard Deviation

SEC=Size Exclusion Column

UV=Ultraviolet

### Reagents

Check materials for any directions regarding expiration or re-standardization.

TABLE 2
Reagents, suppliers, and part numbers.

| | | Part | Con- |
|---|---|---|---|
| Chemicals | Supplier | Number | centration |
| Citric Acid | Sigma | 251275 | 99+% |
| Chitosan Standard (medium | Sigma | 448877 | 99.9−% |
| M_{w}) | | | |
| Cibacron Brilliant Red 3B-A | Sigma | 228451 | 50+% |
| Deionized Water (DIW) | Resistivity >18 | H₂O | |
| | MegaOhm-cm, low | | |
| | halide, low particulate | | |

Note:
All chemicals are reagent or HPLC grade.

### Equipment Preparation

Before sample analysis, perform an HPLC system check: verify that the detector is functioning properly, wash column with citric buffer mobile phase used for elution for at least 30 minutes to stabilize system.

PEEK tubing (or equivalent) should be used for pre-column plumbing. Check for leaks in the tubing connections to the column and instrument. Leaks may lead to inconsistent and erroneous results.

### Calibration

Chitosan standard dilute solutions should be freshly prepared for use within 24 hours of dilution. Standard solutions should be prepared in the concentration range between 0.1 and 1.0 mg/ml.

### Sample Handling and Preservation

To remain in the linear range of the method, chitosan sample concentrations should be diluted to concentrations between 0.01 and 0.10 w %. Store all diluted working solutions at room temperature or cooler (i.e., 5-24° C.) in closed vials or containers. All diluted samples must be analyzed within 24 hours after sample dilution.

### Procedure

### Solution Preparation:

0.10 M Citric Buffer Mobile Phase: Dissolve 19.21 grams of >99% citric acid in 1000 ml of DIW. Adjust pH to 2.95 by adding NaOH solution. Measure pH with a calibrated pH meter.
Derivitizing Reagent: Dissolve 0.250 g of Cibacron Brilliant Red 3B-A (CBR) in 500 ml of the 0.10 M citric buffer mobile phase. The solution should be dark pink in color.
Chromatography Conditions: For chitosan determinations in HR-2010 an isocratic elution (mobile phase remain constant during elution) with 0.1 M citric buffer is sufficient for sample separation without significant interferences. The derivatizing reagent is mixed, post-column, with the mobile phase at a flow rate of 0.12 ml/min. The analytical run is 15 minutes. FIG. 2 shows the chromatogram with the chitosan peak.

FIG. 2. shows a chromatogram of chitosan standard with a TSK-GEL® Size Exclusion column. Analysis is performed with an isocratic elution with 1M citric acid as the mobile phase at a flow rate of 1.0 ml/min. CBR was used as the derivatizing reagent and UV-Visible detection was monitored at 575 nm. Sample injection volume was 60 μL, and column temperature was 24° C. AU is the UV/Vis detector response with arbitrary units.

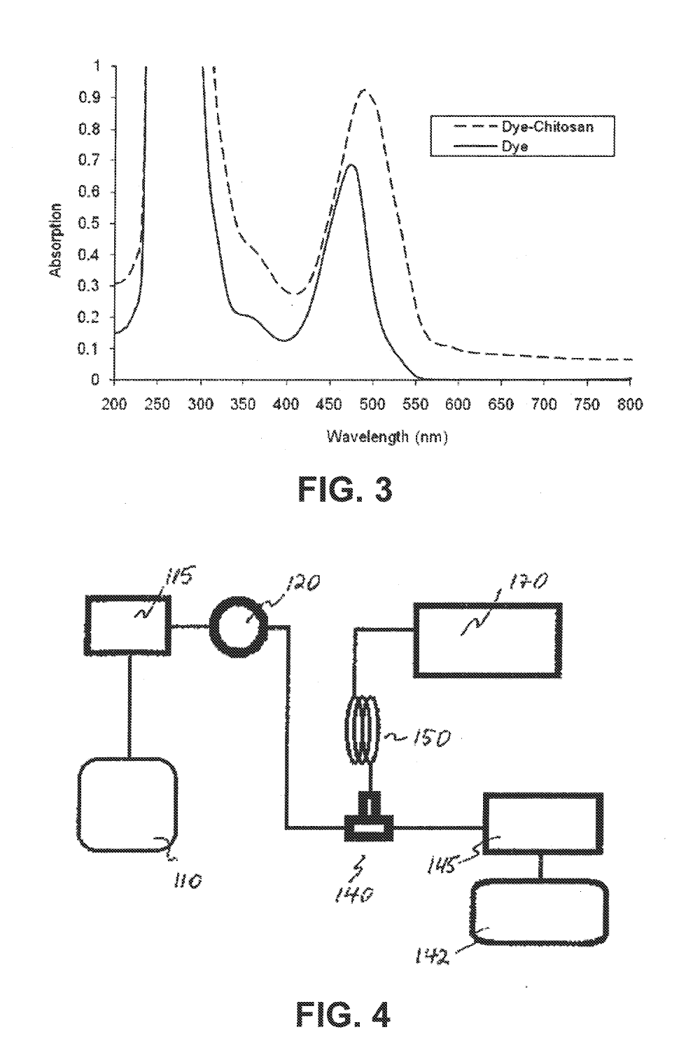

In FIG. 3, the light absorption spectra of CBR and the post-reaction mixture of a chitosan-containing composition test sample with CBR are shown. It is seen that an absorbance peak similar to that in FIG. 2 will result from the difference of the two curves will result, but there will be a substantial tail after the main peak. For this measurement, the HPLC conditions were: Mobile phase: 0.10 M citric buffer, pH 2.95, flow rate: 1.0 ml/min. injection volume: 100 μl. A 1.0 ml loop (0.03″ ID×219 cm TEF tubing) was used between the HPLC injection valve and mixer (a Tee). The volume of this tubing may selected from about 0.05 to 10.0 mL, of which the range is 0.1 to about 1.0 mL in an embodiment. The volume further is selected to reduce the pulse effect from the HPLC pump. In the configuration that includes an analytical column, this loop is generally not necessary and may be absent. The derivatization reagent solution comprised 0.50 mg/ml CBR in 0.10 M Citric buffer, pH 2.95. Flow rate: 0.12 ml/min. The in-line derivatization loop between the tee connection and the diode array absorption detector was a 0.8 ml reaction loop (0.03″ ID×175 cm TEF tubing). The reaction loop volume may be selected from the range of 0.05 to about 5 mL. In one embodiment, this range is from about 0.2 to 0.8 mL, and a volume in the range of about 0.3 to about 0.5 mL is more preferable. This reaction loop is also provides the benefit of resulting in a relatively flat baseline on the chromatograph. The measurement was made at approximately room temperature: ˜24° C.

The calibration curve is established by measuring the absorption for various standard dilutions. Examples of these dilutions are shown below.

TABLE 3
Standard Dilutions for Establishing a Calibration Curve
Medium Molecular Weight Chitosan (>99% w/w)

| STD | |
|---|---|
| Conc. | |
| (μg/ml) | Dilution |
| 1000.0 | Dissolve 100 mg of chitosan powder in 100 ml of 0.1M |
| | citric buffer |
| 700.0 | Dissolve 70 mg of chitosan powder in 100 ml of 0.1M citric buffer |
| 500.0 | Dissolve 50 mg of chitosan powder in 100 ml of 0.1M citric buffer |
| 300.0 | Dissolve 30 mg of chitosan powder in 100 ml of 0.1M citric buffer |
| 100.0 | Dissolve 10 mg of chitosan powder in 100 ml of 0.1M citric buffer |

### Calculations

$${C}_{sample} = \frac{{R}_{sample} - intercept}{slope} \times D$$

### Note:

Cₛₐₘₚₗₑ=Concentration of sample (w/w %)
Rₛₐₘₚₗₑ=Detector response (peak area) from sample
Intercept=Y-intercept from calibration curve
slope=Slope from calibration curve
D=Dilution factor

### Example of Chitosan Calculation

Standards and sample diluted according to above table, e.g. chitosan standard diluted to 0.04% w/w.

$${C}_{sample} = \frac{875288 + 363424}{3151.1955} \times 10$$

### Intercept=363424

### Slope=3151.2

### Rₛₐₘₚₗₑ=875288

### D=10

Cₛₐₘₚₗₑ=393 μg/ml=0.393 w % Chitosan

### QA/QC for Sample Analysis

1. Blank Control and Correction:
The solvent solution that is used for sample dilution and standard preparation will be injected into the HPLC as a blank control. This check is necessary to ensure that no interference peaks result from the solvent or the HPLC system. The first injection (prior to sample runs) should be the blank control. After 20 injections another blank control is required. If the total number of injections is less than 20, the last injection should be the blank control.
If interference peaks appear from the solvent, prepare fresh solvent solution and flush the column. If extraneous peaks are found as a result of contamination in the HPLC system, then prepare fresh mobile phases and flush the column for at least 30 minutes. If interference peaks are still present, clean the HPLC system by install clean tubing, pump, injection valve, etc.
The interference peaks must be completely removed before sample analysis.

2. Standard Check and Correction:

Two standard solutions should be used for the standard check. The concentration of the standard solutions should be in the range 0.1 and 1.0 mg/ml. If the number of sample runs is less than 20, the second injection should be the standard check, and another standard check may be injected to the HPLC prior to the last blank control. For every 10 sample injections, another standard check is required. If the standard check deviation is greater than 5%, a fresh standard solution should be prepared and tested. If the deviation is still greater than 5% and the HPLC system is operating correctly, then the concentrated standard should be appropriately diluted and validated by titration, then, a new calibration curve should be made. Otherwise, maintenance of the HPLC system should be performed.

3. Peak Integration:
Manually integrate the analyte peak of interest to determine its area from baseline (peak start) to baseline (peak end) and then integrate the peak of interest with chromatography software. Compare the software-integrated and manually integrated results for agreement.

4. Relative Standard Deviation (RSD) and Correction:
Each sample should be performed in triplicate, and the RSD should be less than 3%. If the RSD is greater than 3%, 1) prepare new samples or 2) use 0.50 mg/ml standard solution to check the RSD (use seven injections to calculate the RSD). If an unacceptably large RSD still results, then the variation may be the result of HPLC system malfunction, e.g., out-of-specification injection. Perform system inspection and testing, and replace parts and repair the system as needed.

Exemplary tests have been performed to determine the chitosan concentration in a composition designated HR-2010. This composition is an acid solution that also contains hydantoin. Various dilutions of HR-2010 have been prepared. Typical RSDs of the analytical method for HR-2010 are listed in Table 4.

TABLE 4
Analytical Method Relative Standard Deviations for Chitosan
Analysis at Varying Concentrations

| Concentration | Relative Standard |
|---|---|
| (%) | Deviation (%) |
| 0.01 | 9.53 |
| 0.03 | 1.58 |
| 0.05 | 2.21 |
| 0.07 | 1.88 |
| 0.1 | 2.37 |

### Variability Calculations:

The net relative error of the calculations results, to first order, as the cumulative relative errors of the parameters of the calculation, i.e., the sum of the relative errors. Variation within the limits of such errors is to be expected. Instrument variation may be expected to be less than ±2%.

The most likely source of variation is the dilution of samples and standards. Dilutions should be performed with transfer quantities that amount to the majority of the dynamic range of the pipetter or other measuring device.

In another embodiment, fluorescent detection of the reaction product of chitosan with derivatizing dye is used to quantitatively measure the concentration of chitosan. Chitosan is effectively non-fluorescent, and CBR is a non-fluorescence derivatization reagent. Fluorescent reaction product is generated when chitosan and CBR are mixed.

In this embodiment, the configuration of the apparatus for performing the method is shown in FIG. 4. The apparatus comprises a binary mixer or tee 140, a reaction loop 150, and a detector 170. A mobile phase 110 is transferred by a pump 115 into an injection valve 120 that injects the analyte containing sample and mobile phase into the mixer or tee 140. Also entering the mixer or tee is the derivatizing agent 142 that is injected via a metering pump 145. The mobile phase carrying the analyte and the derivatizing agent exit the mixer or tee 140 and are conveyed through a reaction loop 150 to a detector 170. In one embodiment, the injection of test sample aliquot is made through an injection valve 120 that is a 6-port valve assembly as is typically found in use in automatic samplers that are widely used in chromatography systems. In this embodiment, the buffered mobile phase 110 and test sample aliquot pass through the tee 140 into the tube comprising the reaction loop 150 that contains the flowing dye solution comprising the derivatizing agent 142.

In some embodiments, the derivatization reaction loop volume is between 200 and 800 μl. In another embodiment the tubing comprises 0.03: ID TEF tubing. As with the embodiment described above, a 6-port valve may be used for test sample injection. Such a valve may be preferable because such valves are commonly available in analytic laboratories and manufacturing plants where chromatography is performed.

Fluorescence detection may be preferable when the test sample contains interferants compounds that make light absorption detection problematic. Seen in FIG. 3 is the absorption spectrum shift after CBR reacts with chitosan. The second maximum absorption shifts from 462 nm to 487 nm. Because the second maximum absorptions are almost overlapped, it is difficult to use the wavelengths to determine the chitosan concentration. Between 560 to 600 nm, the reaction products of chitosan and CBR exhibit an absorption peak, which is very weak for CBR alone. So, this wavelength may be preferable for the quantitative determination of analyte concentration. However, if any interferences in the test sample exhibit absorption near these wavelengths, the direct in-line derivatization method with light absorption detection may not be accurate. When using light absorption detection, the interferences should be separated from the chitosan. In contrast, fluorescent detection offers an attractive alternative embodiment in the presence of light absorption interferants because most compounds in the sample will not generate fluorescence interference. So, it is likely not necessary to separate the interferences with the chitosan signal when fluorescence detection is employed, and so, the configuration is simplified.

In another embodiment using fluorescence detection, illustrative materials, conditions, and procedures are described below.

### Equipment

Hitachi D-7000 HPLC system with a Hitachi 7485 Fluorescence detector, L-7200 autosampler and L-7100 pump, or an equivalent system.
Secondary Pump for post column derivatization capable of delivering up to 1.5 ml/min.
Binary Mixer for mixing reagent and chitosan sample. 25 μl PEEK mixer cartridge
Reaction loop for derivatization. 410 μl (0.03″ ID×90 cm); An 800 μl reaction loop can be used in place of the binary mixer. The reaction loop, preferably, is made of PEEK or FEP plastic.
HPLC autosampler vials: 1.6 ml, glass or HDPE
Adjustable Transfer pipetters for dilutions (Eppendorf type covering range of 2 μL to 2.5 ml). Typical analyte and standard aliquots should comprise approximately 20-1000 μL.
Disposable pipetter tips to avoid cross contamination
Dilution vials

### Reagents

Check materials for any directions regarding expiration or re-standardization.

| | | Part | Con- |
|---|---|---|---|
| Chemicals | Supplier | Number | centration |
| Citric Acid | Sigma | 251275 | 99+% |
| Chitosan Standard (medium | Sigma | 448877 | 99.9+% |
| M_{w}) | | | |
| Cibacron Brilliant Red 3B-A | Sigma | 228451 | 50+% |
| De-ionized Water (DIW) | Resistivity >18 | H₂O | |
| | MegaOhm-cm, low | | |
| | halide, low particulate | | |

Note:
All chemicals are reagent or HPLC grade.

### Equipment Preparation

Before sample analysis, perform an HPLC system check: verify that the detector is functioning properly, wash column with citric buffer mobile phase used for elution for at least 30 minutes to stabilize system.

PEEK tubing (or equivalent) should be used for pre-column plumbing. Check for leaks in the tubing connections to the column and instrument. Leaks may lead to inconsistent and erroneous results.

### Calibration

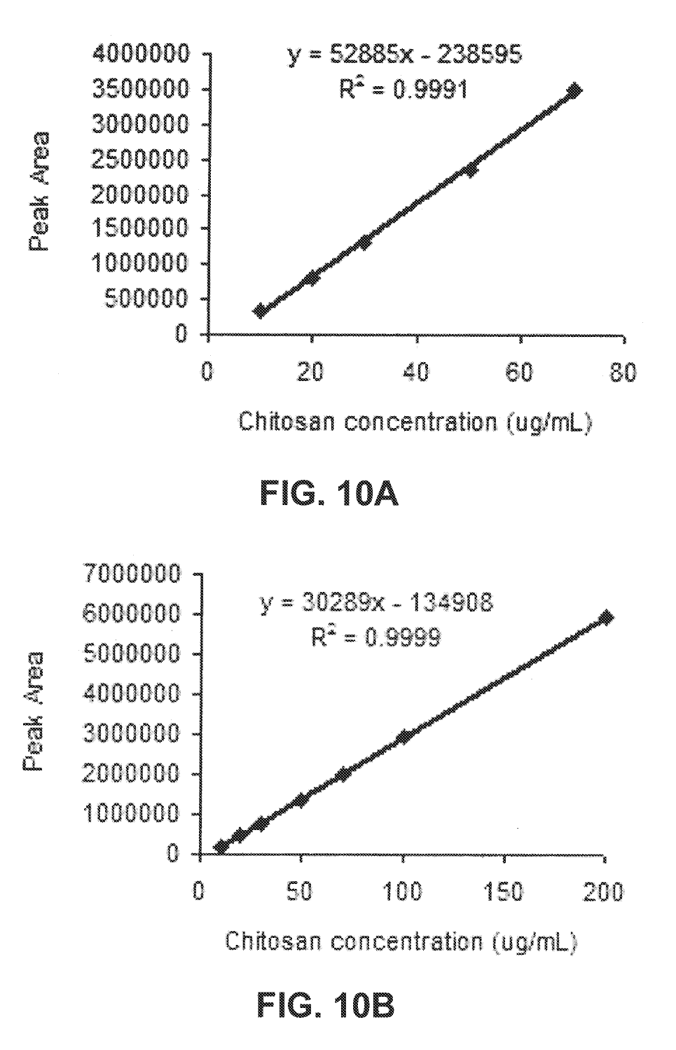

Chitosan standard dilute solutions should be freshly prepared for use within 24 hours of dilution. Standard solutions should be prepared in the concentration range between 0.01 and 1.0 mg/ml. FIG. 10 shows a calibration curve for the fluorescence method.

### Sample Handling and Preservation

To remain in the linear range of the method, chitosan sample concentrations should be diluted to concentrations between 0.01 and 0.10 w %. Store all diluted working solutions at room temperature or cooler (i.e., 5-24° C.) in closed vials or containers. All diluted samples must be analyzed within 24 hours after sample dilution.

### Procedure

### Solution Preparation:

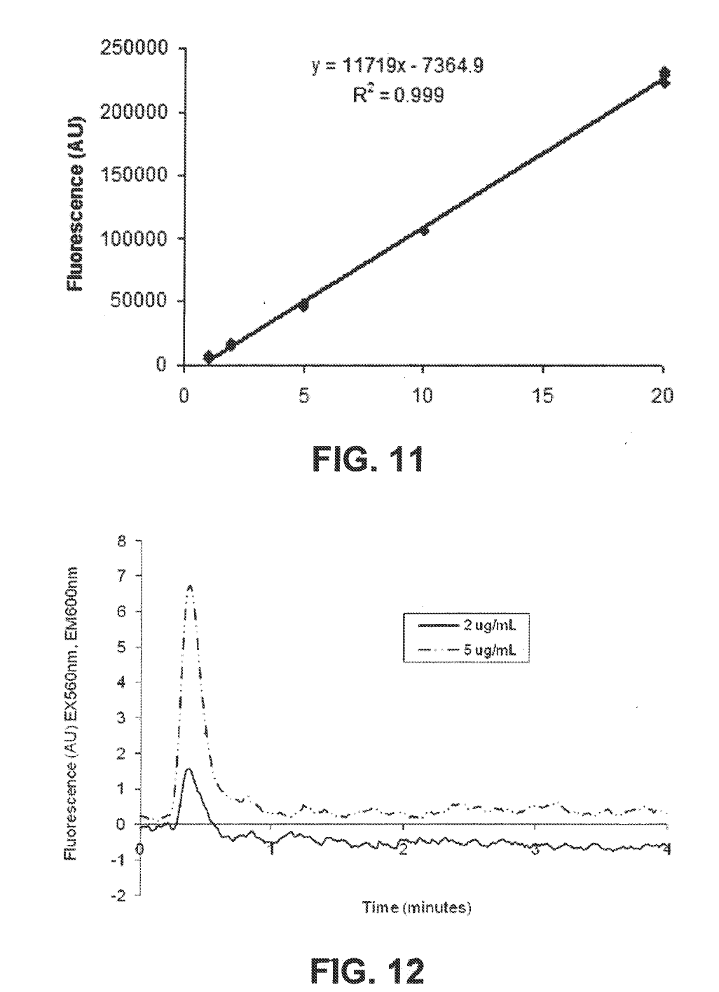

0.10 M Citric Buffer Mobile Phase: Dissolve 19.21 grams of >99% citric acid in 1000 ml of DIW. Adjust pH to 2.95 by adding NaOH solution. Measure pH with a calibrated pH meter.
Derivitizing Reagent: Dissolve 0.250 g of Cibacron Brilliant Red 3B-A in 500 ml of the 0.10 M citric buffer mobile phase. The solution should be dark pink in color.
Chromatography Conditions: For chitosan determinations in HR-2010 an isocratic program (mobile phase remain constant during elution) with 0.1 M citric buffer is appropriate for the mobile phase. The derivatizing reagent is mixed with the mobile phase at a flow rate of 0.12 ml/min. The analytical run is 5 minutes. FIG. 11 shows a chromatogram with the chitosan peak.

### Standard Dilutions

Medium Molecular Weight Chitosan (>99% w/w)

| STD | |
|---|---|
| Conc. | |
| (μg/ml) | Dilution |
| 1000.0 | Dissolve 100 mg of chitosan powder in 100 ml of 0.1M |
| | citric buffer |
| 700.0 | Dissolve 70 mg of chitosan powder in 100 ml of 0.1M citric buffer |
| 500.0 | Dissolve 50 mg of chitosan powder in 100 ml of 0.1M citric buffer |
| 300.0 | Dissolve 30 mg of chitosan powder in 100 ml of 0.1M citric buffer |
| 100.0 | Dissolve 10 mg of chitosan powder in 100 ml of 0.1M citric buffer |

### HR-2010™ Sample Dilutions

Chitosan (nominally 0.4% w/w)

Dilute HR-2010 sample to 0.04% w/w
Transfer 1.00 ml of sample solution to 9.00 ml of 0.1 M Citric Acid

### Calculations

$${C}_{sample} = \frac{{R}_{sample} - intercept}{slope} \times D$$

### Note:

Cₛₐₘₚₗₑ=Concentration of sample (w/w %)
Rₛₐₘₚₗₑ=Detector response (peak area) from sample
Intercept=Y-intercept from calibration curve
slope=Slope from calibration curve
D=Dilution factor

### Example of Chitosan Calculation

Standards and sample diluted according to above table, e.g. chitosan standard diluted to 0.04% w/w.

### Intercept=363424

### Slope=3151.2

### Rₛₐₘₚₗₑ=875288

### D=10

Cₛₐₘₚₗₑ=393 μg/ml=0.393 w % Chitosan

$${C}_{sample} = \frac{875288 + 363424}{3151.1955} \times 10$$

### QA/QC for Sample Analysis

5. Blank Control and Correction:
The solvent solution that is used for sample dilution and standard preparation will be injected into the HPLC as a blank control. This check is necessary to ensure that no interference peaks result from the solvent or the HPLC system. The first injection (prior to sample runs) should be the blank control. After 20 injections another blank control is required. If the total number of injections is less than 20, the last injection should be the blank control.
If interference peaks appear from the solvent, prepare fresh solvent solution and flush the column. If extraneous peaks are found as a result of contamination in the HPLC system, then prepare fresh mobile phases and flush the column for at least 30 minutes. If interference peaks are still present, clean the HPLC system by install clean tubing, pump, injection valve, etc.
The interference peaks must be completely removed before sample analysis.

6. Standard Check and Correction:
Two standard solutions should be used for the standard check. The concentration of the standard solutions should be in the range 0.1 and 1.0 mg/ml. If the number of sample runs is less than 20, the second injection should be the standard check, and another standard check may be injected to the HPLC prior to the last blank control. For every 10 sample injections, another standard check is required. If the standard check deviation is greater than 5%, a fresh standard solution should be prepared and tested. If the deviation is still greater than 5% and the HPLC system is operating correctly, then the concentrated standard should be appropriately diluted and validated by titration, then, a new calibration curve should be made. Otherwise, maintenance of the HPLC system should be performed.

7. Peak Integration:
Manually integrate the analyte peak of interest to determine its area from baseline (peak start) to baseline (peak end) and then integrate the peak of interest with chromatography software. Compare the software-integrated and manually integrated results for agreement.

8. Relative Standard Deviation (RSD) and Correction:
Each sample should be performed in triplicate, and the RSD should be less than 3%. If the RSD is greater than 3%, 1) prepare new samples or 2) use 0.50 mg/ml standard solution to check the RSD (use seven injections to calculate the RSD). If an unacceptably large RSD still results, then the variation may be the result of HPLC system malfunction, e.g., out-of-specification injection. Perform system inspection and testing, and replace parts and repair the system as needed.

### Variability Calculations:

The net relative error of the calculations results, to first order, as the cumulative relative errors of the parameters of the calculation, i.e., the sum of the relative errors. Variation within the limits of such errors is to be expected. Instrument variation may be expected to be less than ±2%.

The most likely source of variation is the dilution of samples and standards. Dilutions should be performed with transfer quantities that amount to the majority of the dynamic range of the pipetter or other measuring device.

### Examples of Tests Using the Assay Method

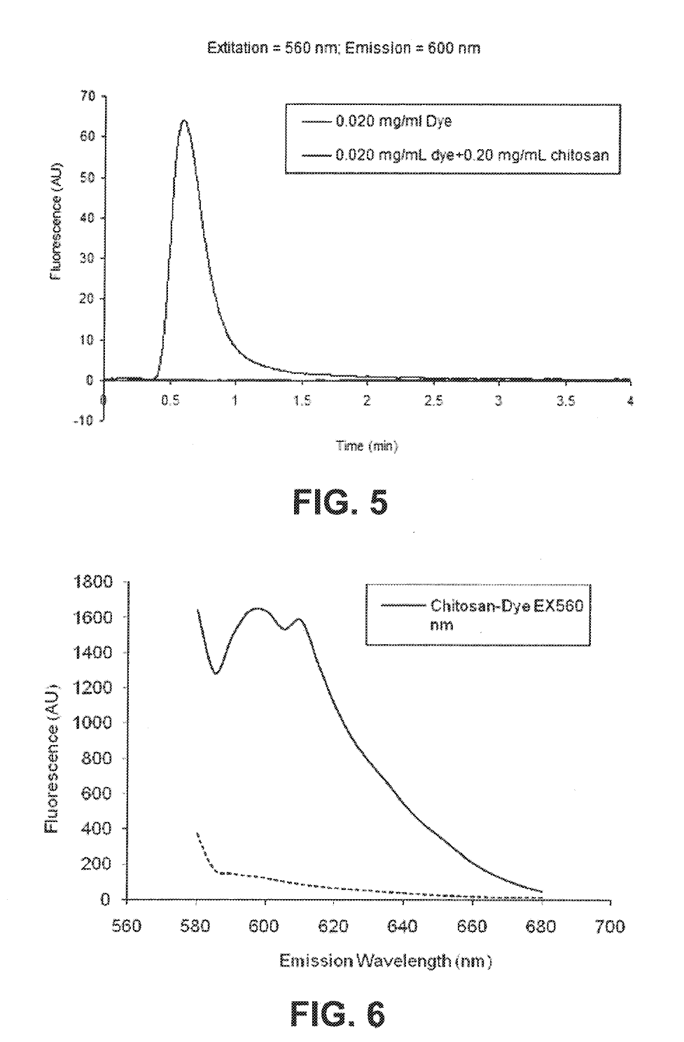

FIG. 5 displays the fluorescence intensity of CBR dye and the chitosan plus CBR derivatization reaction product as a function of time. It is seen that the CBR dye is essentially non-fluorescent at 600 nm detection with excitation at 560 nm. At the same excitation wavelength, 560 nm, the derivatization reaction product exhibits a well defined emission curve at 600 nm that has a tail that returns to the baseline with a full width at half maximum of about 0.3 minutes.

In FIG. 6, the fluorescence amplitude is shown as a function of emission wavelength, i.e., an emission scan spectrum. The upper curve (solid line) is the emission scan spectrum for the chitosan-dye derivatization product with an excitation wavelength of 560 nm. The lower curve (dashed line) is the emission scan spectrum for the dye alone with an excitation wavelength of 560 nm. For this comparison, 0.4 mg/ml chitosan of medium molecular weight (MMW) reacts with 0.02 mg/ml derivatizing CBR dye solution. Mobile phase solvent is 0.1 M citric buffer, pH 2.95. Peak emission of the chitosan-dye reaction product is at a wavelength of about 600 nm.

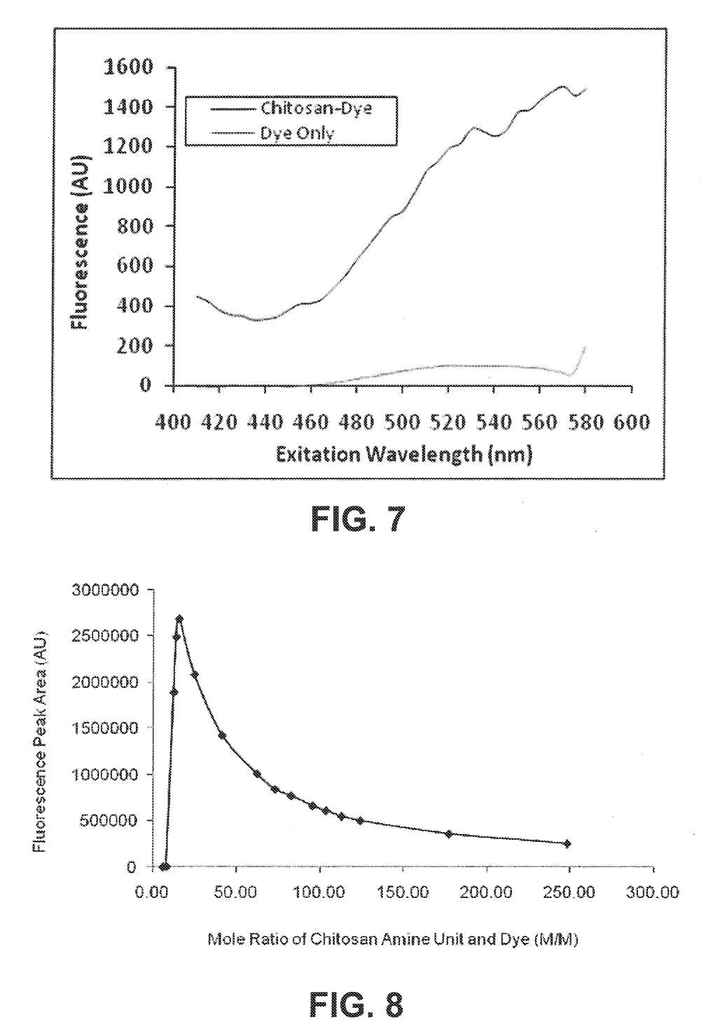

The fluorescence amplitude is shown in FIG. 7 as a function of excitation wavelength, i.e., a excitation scan spectrum. The upper curve (solid line) is the excitation scan spectrum for the chitosan-dye derivatization product in mobile phase. The lower curve (dashed line) is the excitation scan spectrum for the dye alone. For this comparison, 0.4 mg/ml chitosan, MMW, reacts with 0.02 mg/ml derivatizing CBR dye solution. The mobile phase solvent is 0.1 M citric buffer with pH=2.95. The excitation of chitosan-dye reaction product yields a peak fluorescence at about 575 nm.

FIG. 8 shows the dependence of the fluorescence signal on the mole ratio of chitosan amine unit and dye. The concentration of the chitosan amine unit is 0.62 mM, and the dye concentration is varied from 0.002 mM to 0.5 mM. Peak fluorescence is obtained when the mole ratio is about 20.

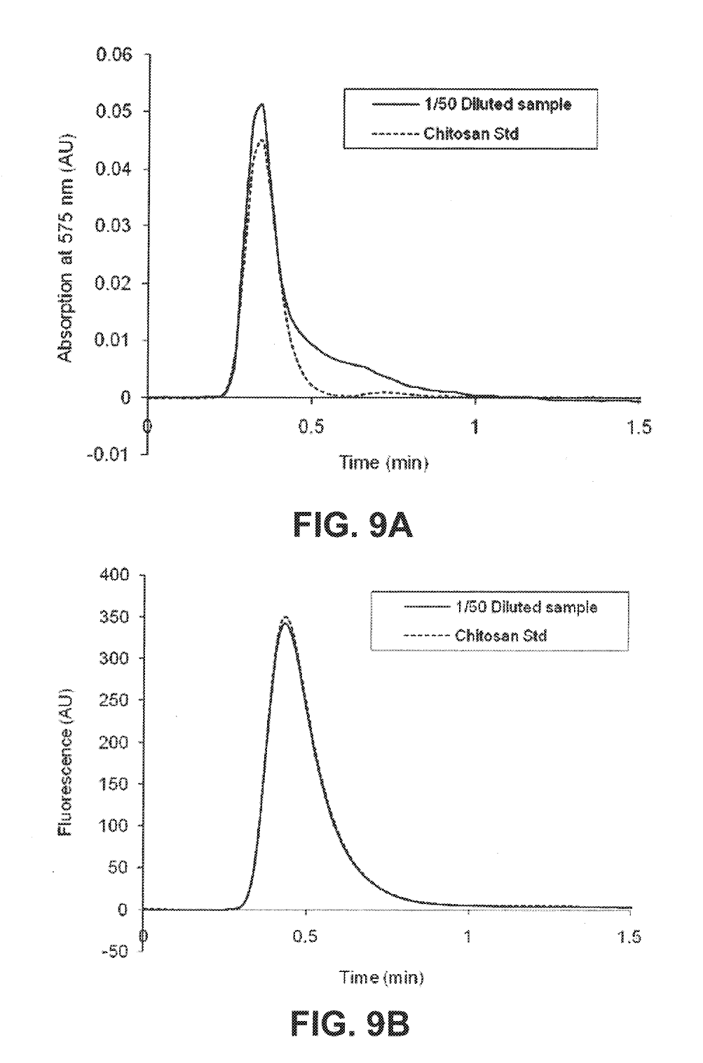

FIG. 9 shows a comparison of light absorption detection and fluorescence detection. In (a) are the absorption measurements of chitosan in a test sample comprising a chitosan composition (HR2010) and chitosan standard (medium molecular weight from Sigma by the direct in-line derivatization method with absorption detection. In (b) are the fluorescence measurements of chitosan in a test sample comprising a chitosan composition (HR2010) and chitosan standard (medium molecular weight from Sigma) by the direct in-line derivatization method with fluorescence detection. The excitation wavelength is 560 nm, and the emission is measured at 600 nm wavelength. The HPLC conditions were: 0.1 M citric buffer, pH 2.95 used as a mobile phase, the flow rate is 1.0 ml/min, injection volume is 100 μl, reaction loop is 410 μl with a Tee. Derivatization reagent: 0.2 mg/ml Cibacron Brilliant red 3B-A dissolved in 0.1 M citric buffer, pH 2.95, the flow rate is 0.3 ml/min.

Because of the precipitate problem, the dynamic range of the calibration curve depends on the chitosan concentration, derivatization reagent concentration, the flow rates, as well as the injection volume, and other parameters. FIG. 10 shows a comparison of the calibration curves for a test sample injection aliquot volume of 50 μl (a) and 100 μl (b). In these measurements, fluorescence detection is used. For these measurements the test parameters were as follows: 0.1 M citric buffer mobile phase with pH=2.95, the flow rate is 1.0 ml/min; the CBR derivatization reagent dye solution comprises 0.1 mg/ml CBR in 0.1 M citric buffer, and the flow rate is 0.50 ml/min. The reaction loop is 800 μl. It is seen that the smaller injection aliquot volume results in a larger dynamic range.

Reproducibility: The direct on-line derivatization with fluorescence detection for quantitative determination of chitosan appeared high reproducibility. Table 5 lists the test results.

TABLE 5
Reproducibility test data.

| | Peak area | | |
|---|---|---|---|
| Test # | 10 ug/ml | 50 ug/ml | 70 ug/ml |
| 1 | 354693 | 2526426 | 3702372 |
| 2 | 365005 | 2484793 | 3650528 |
| 3 | 357213 | 2562885 | 3734471 |
| 4 | 360567 | 2528614 | 3661853 |
| 5 | 363945 | 2535702 | 3692240 |
| 6 | 362450 | 2539989 | 3611646 |
| 7 | 357419 | 2538881 | 3698550 |
| Average | 360184.6 | 2531041 | 3678809 |
| SD | 3857.7 | 23605.7 | 40459.4 |
| RSD (%) | 1.07 | 0.93 | 1.10 |

Note:
SD = standard deviation, RSD = relative standard deviation. HPLC condition: 0.1M citric buffer, pH 2.95 as a mobile phase, flow rate is 1.0 mL/min. Derivatization reagent: 0.10 mg/mL Cibacron Brilliant Red 3B-A in the 0.1M citric buffer, flow rate is 0.5 mL/min. 800 uL reaction loop, injection volume is 100 uL. Excitation wavelength is 560 nm, and the emission wavelength is 600 nm.

Detection limit: The detection limit is ≦1 μg/ml when the HPLC conditions are: 0.1 M citric buffer, pH=2.95 used as the mobile phase, the flow rate is 1.0 ml/min. Derivatization reagent: 0.1 mg/ml CBR in the citric buffer, the flow rate is 0.5 ml/min, 800 μl reaction loop (made by 0.03″ ID TEF tubing). The injection volume is 100 μl. Excitation wavelength is 560 nm, and the emission wavelength is 600 nm.

FIG. 11 shows the calibration curve of the direct in-line derivatizing method with fluorescence detection, excitation=560 nm, emission=600 nm, 100 μl injection.

FIG. 12 shows the fluorescence signals as a function of time for chitosan determination by direct in-line derivatization with fluorescence detection. Injection volume is 60 μl. The excitation wavelength is 560 nm, and the emission is detected at a wavelength of 600 nm. With selection of an appropriate dye concentration in the mobile phase, the method can measure chitosan in the μg/ml range. The upper curve (solid line) is the signal for 5 μg/ml. The lower curve (dashed line) is the signal for 2 μg/ml.

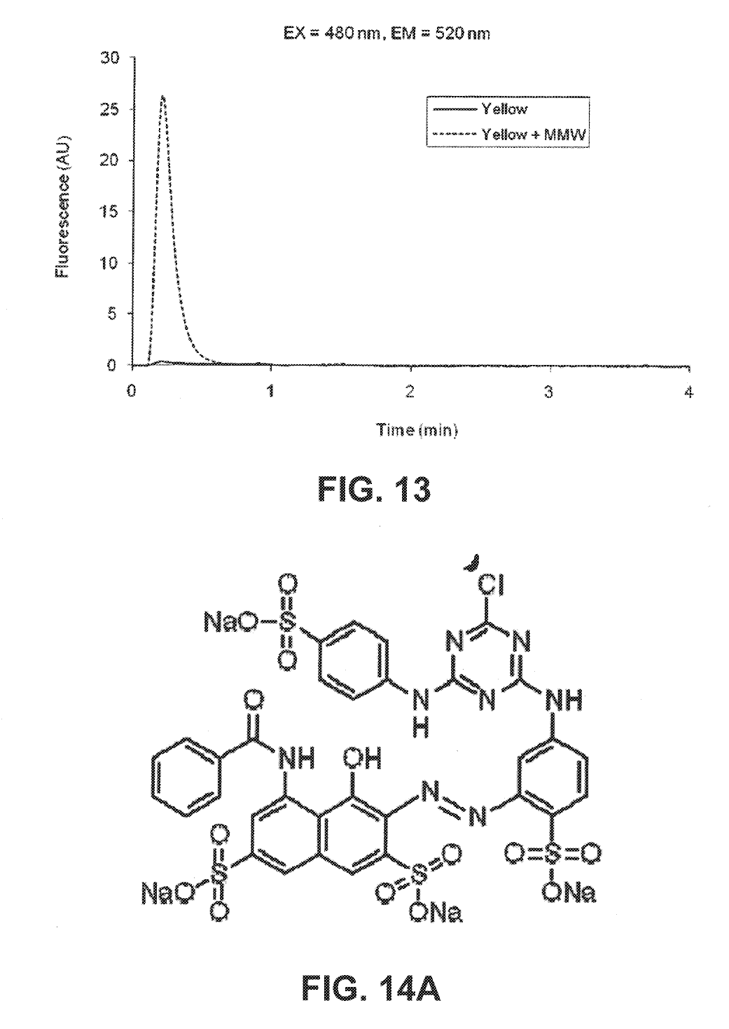

FIG. 13 shows the fluorescence intensity as a function of time for Cibacron Yellow 3G-P dye (lower, dashed line) and chitosan reacted with Cibacron Yellow 3G-P dye (upper, solid line). The dye alone has almost no fluorescence amplitude in comparison with the chitosan/CBY product.

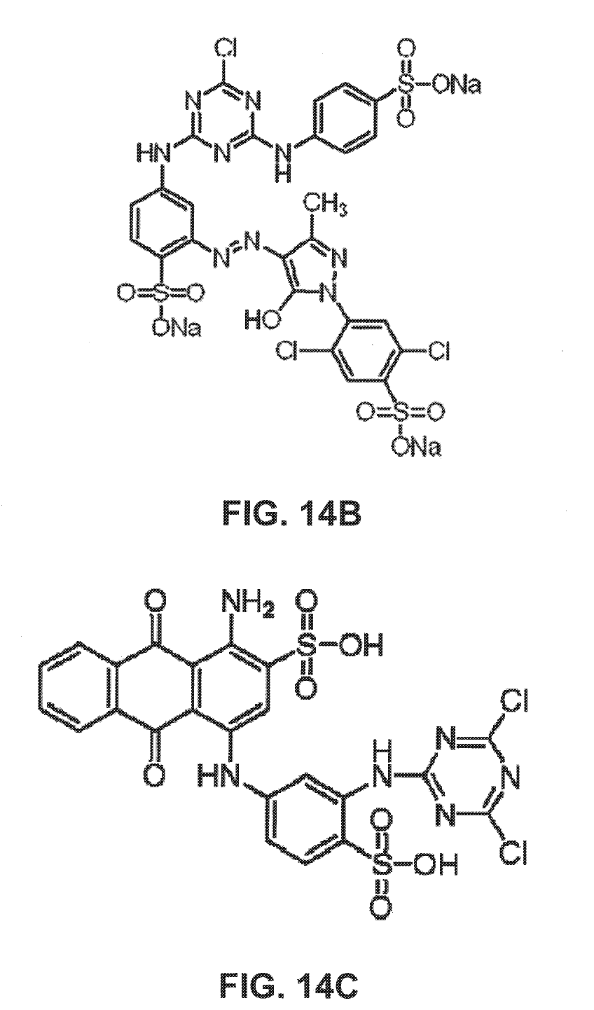

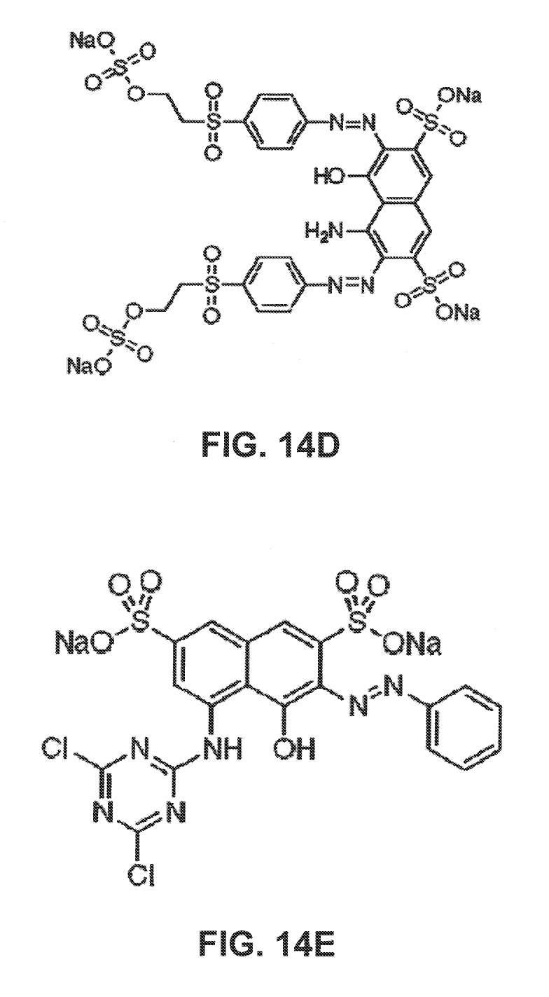

The assay method was repeated with selection of several different sulfonates dyes. The included: Cibacron Brilliant Red 3B-A, Cibacron Brilliant Yellow 3G-P, Reactive Blue 4, Reactive Black 5, and Procion Red MX-5B. The molecular structures of these dyes are shown in FIG. 14. Of the dyes shown, only Cibacron Red 3B-A/chitosan and Cibacron Yellow 3G-P/chitosan showed useful fluorescence signals. Yellow 3G-P/chitosan produced a smaller fluorescence signal than Red 3B-A/chitosan. It is thought that dyes useful in the method will have two or more sulfonates groups, and they will have a conformation, shape, and size that readily match the spacing of accessible reactive groups, e.g., amines, on the polyaminosaccharide polymer so as to react and form fluorescent derivative product.

From the foregoing description, various modifications and changes in the compositions and method will occur to those skilled in the art without varying from the scope of the invention as defined in the following claims.

1. A method for determining the concentration of polyaminosaccharide polymer in a test sample, the method comprising:
flowing a derivatizing dye solution through a tube to a detector;
injecting an aliquot of the test sample into a buffered mobile phase solution;
flowing the buffered mobile phase solution into the tube that contains the flowing derivatizing dye solution;
mixing the test sample and the derivatizing dye solution to form a reaction product by the contact of the dye solution and the test sample;
detecting the reaction product to obtain a quantitative measure; and
comparing the quantitative measure of the reaction product detection with a calibration curve that is established by the quantitative measure of two or more samples containing known concentrations, of which at least two are differing, of the polyaminosaccharide polymer.

2. The method of claim 1, wherein the polyaminosaccharide polymer is a chitosan polymer.

3. The method of claim 2, wherein the derivatizing dye solution contains an anionic sulfonates dye having two or more sulfonates groups.

4. The method of claim 3, wherein the derivatizing dye solution contains a dye selected from the group comprising Cibacron Brilliant Red 3B-A and Cibacron Brilliant Yellow 3G-P.

5. The method of claim 2, wherein detecting comprises detecting by either or both of light absorption and fluorescence.

6. The method of claim 2, wherein the buffered mobile phase solution is 0.1 M citric acid.

7. The method of claim 1, wherein flowing a buffered mobile phase solution comprises flowing the solution through a tee or a binary mixer.
